(19) United States
(12) Patent Application Publication
(10) Pub. No.: US 2006/0152354 A1
(43) Pub. Date: Jul. 13, 2006

(54) Stolen vehicle reporting system

(76) Inventor: Scott Jones, Auburn, CA (US)

Correspondence Address: TROJAN LAW OFFICES, 9250 WILSHIRE BLVD, SUITE 325, BEVERLY HILLS, CA, 90212, US

(21) Appl. No.: 11/023,222

(22) Filed: Dec. 27, 2004

(51) Int. Cl. G08B 26/00

(52) U.S. Cl. 340/505

(57) ABSTRACT

A stolen vehicle reporting system to which a user subscribes and corresponding method is provided. The method provides that when the user observes information sufficient to identify a vehicle and its location, the user contacts a server with a database of reported stolen vehicle information via an IO device. The user then enters the observed information into the server via the IO device and receives information from the server via the IO device that identifies whether the observed vehicle is reported stolen. If the database reports that the vehicle is reported stolen, then the user reports the location of the vehicle to police. The user then requests a reward from the server for reporting of a stolen vehicle and the server compares the request to police reports to determine if the stolen vehicle was recovered. If the server confirms the recovery of the stolen vehicle, then the user received a reward from the server.

### FIELD OF THE INVENTION

The invention relates to a stolen vehicle reporting system and method and, more particularly, to a stolen vehicle reporting system and method whereby a user subscribes to the system, observes information sufficient to identify a vehicle and its location, contacts a server with a database of reported stolen vehicle information, enters the observed information, receives information from the server whether the vehicle is reported stolen, reports the location of the vehicle to police and requests and receives a reward from the sponsors of the server if recovery of the stolen vehicle is confirmed.

### BACKGROUND OF THE INVENTION

Automobile theft is a serious problem and one of the most prevalent crimes in today's society. Federal Bureau of Investigation (FBI) statistics indicate that there were 1.2 million vehicles stolen in the United States in 2002, worth approximately $8.4 billion. There is a shortage of law enforcement and police officers in general and those who are employed can only dedicate a minimal amount of time to tracking down stolen vehicles. In large metropolitan areas, and especially in those with high crime rates, law enforcement officers are preoccupied with dealing with crimes that are violent in nature such as murder, robberies and rape. Society places a preference for law enforcement officers to first concentrate on crimes involving bodily injury over those involving mere property offenses. Therefore, many crimes involving property offenses, in particular vehicle theft, remain unsolved and, consequently, many stolen vehicles are never recovered. A need exists for a method of recovering stolen vehicles that does not limit enforcement to law enforcement and police officers.

Furthermore, while law enforcement and police officers are engaged in stopping crimes involving bodily injury, major metropolitan throughways, intersections and other areas are populated with lay people. Many of these lay people share a desire to successfully recover vehicles that are reported stolen. A need exists for a method that allows a lay person to participate in the recovery of stolen vehicles.

Although many lay people may wish to increase the number of stolen vehicles that are recovered, a mere desire may not be enough incentive for them to act to help accomplish this goal. Therefore, a need exists for a method that confers a reward upon a lay person who successfully reports a stolen vehicle that eventually gets recovered.

### SUMMARY OF THE INVENTION

In accordance with the present invention, a stolen vehicle reporting system and method is provided. The method involves steps taken by a user who participates in the recovery of stolen vehicles and is rewarded for the successful reporting of a recovered stolen vehicle.

In accordance with one aspect of the present invention, a user subscribes to the reporting system. In a preferred embodiment, the user subscribes to the system for a fee.

In accordance with another aspect of the present invention, the user observes information sufficient to identify a vehicle and its location. It is contemplated that the information includes license plate information. It is further contemplated that the information includes make, model, color and location information.

In accordance with still another aspect of the present invention, the user contacts a server with a database of stored reported stolen vehicle information via an input/output (IO) device. In one embodiment, the user contacts the server through contacting a human operator via the IO device who then interfaces with said server. It is contemplated that the IO device is wireless. In one embodiment, it is a cellular telephone. In an alternate embodiment, the IO device is any IO device known in the art.

In accordance with yet another aspect of the present invention, the user enters the observed information via the IO device into the server. It is contemplated that before the user enters the observed information, he or she enters an ID and password after contacting the server.

In accordance with another aspect of the present invention, the user receives information from the server via the IO device identifying whether the vehicle is reported stolen. It is contemplated that in determining whether the vehicle is reported stolen, the server compares the observed information against the information stored in the database. It is further contemplated that the database is configured to receive updated reported stolen vehicle information. It is still further contemplated that the server is configured to receive police reports of recovered stolen vehicles. It is yet further contemplated that the server stores the entered observed information.

In accordance with still another aspect of the invention, the user reports the location of the vehicle to police if the server reported that the vehicle was stolen. In one embodiment, that the reporting is via said IO device.

In accordance with yet another aspect of the invention, the user requests a reward from the server for reporting of a stolen vehicle. It is contemplated that the server compares the request to police reports to determine if the stolen vehicle was recovered. In an alternate embodiment, the user does not request the reward.

In accordance with another aspect of the invention, the user receives the reward from the server if recovery of the stolen vehicle is confirmed.

### BRIEF DESCRIPTION OF THE DRAWINGS

FIG. 1 is a flow chart illustrating a method of observing vehicle information, contacting a server via an IO device, entering the observed information and receiving information from the server whether the observed vehicle is reported stolen in accordance with the invention.

FIG. 2 is a flow chart illustrating a method of reporting a location of a vehicle that is reported stolen to police, requesting a reward from a server for reporting a stolen vehicle and receiving a reward from the server after the server compares the request to police reports to determine if the stolen vehicle was recovered in accordance with the invention.

FIG. 3 is a flow chart illustrating an alternative method of reporting a location of a vehicle that is reported stolen to police in accordance with the invention.

### DETAILED DESCRIPTION OF THE INVENTION

This invention includes all alternatives, modifications and equivalents that may be encompassed within the spirit and scope of the invention, as defined by the appended claims. The invention is not limited to the embodiments described herein. Throughout the following description, like numerals and letters refer to like parts or steps.

In accordance with the present invention, a stolen vehicle reporting system and method is provided. The method involves steps taken by a user who participates in the recovery of stolen vehicles and who is rewarded for the successful reporting of a recovered stolen vehicle. It is contemplated that the user subscribes to the service for a fee.

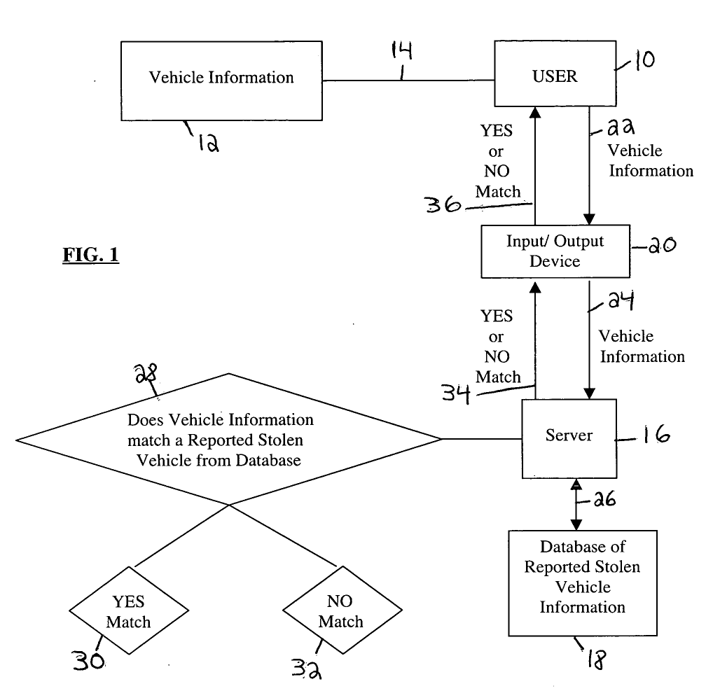

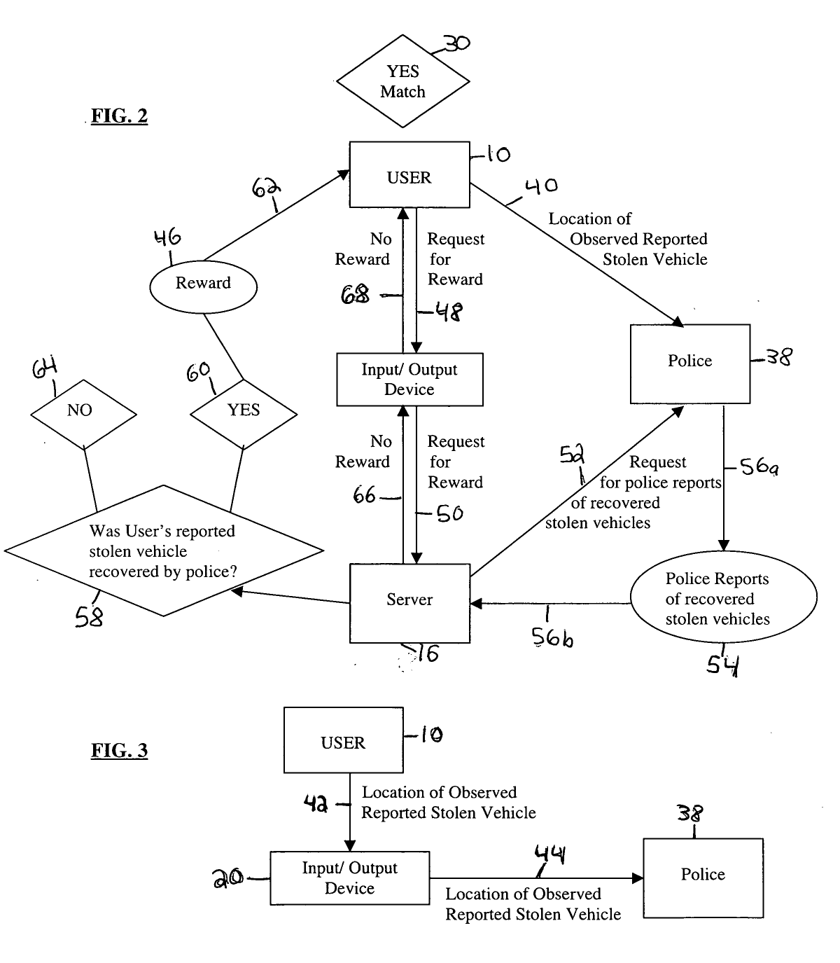

The sequential steps involved in utilizing the system to report a stolen vehicle and obtain a reward are illustrated in flow chart format in FIGS. 1 and 2. FIG. 1 illustrates the steps taken by a user 10 to determine whether vehicle information 12 user has observed, shown as stream 14, is reported stolen. It is contemplated that vehicle information 12 includes information that is sufficient to identify a vehicle and its location and may include license plate, vehicle make, model, type, color and location information.

In the illustrated embodiment, upon observation of vehicle information 12, shown as stream 14, user 10 contacts a server 16 with a database 18 of stored reported stolen vehicle information via an IO device 20. In an alternate embodiment, user 10 contacts server 16 through contacting a human operator via IO device 20 who then interfaces with server 16. Preferably, IO device 20 is wireless and in a preferred embodiment, IO device 20 is a cellular telephone. Alternately, it is contemplated that IO device 20 is any IO device 20 known in the art.

After user 10 contacts server 16, user 10 enters observed vehicle information 12 into IO device 20, illustrated as stream 22. IO device 20 further conveys observed vehicle information 12 to server 16, illustrated as stream 24. In one embodiment, before user 10 enters observed vehicle information 12, user 10 enters an ID and password after contacting server 16.

Further in accordance with the invention, upon receiving observed vehicle information 12, server 16 compares observed vehicle information 12 against database 18 of stored reported stolen vehicle information, illustrated as stream 26. Server 16 then determines whether observed vehicle information 12 matches a reported stolen vehicle from database 18, as illustrated in step 28. If observed vehicle information 12 matches a reported stolen vehicle from database 18, server 16 issues a response of YES match 30. If observed vehicle information 12 does not match a reported stolen vehicle from database 18, server 16 issues a response of NO match 32. In accordance with the invention, database 18 is configured to receive updated reported stolen vehicle information. It is contemplated that database 18 receives updated reported stolen vehicle information from a source with current reported stolen vehicle information, such as a Department of Motor Vehicle, Secretary of State, law enforcement or similar source.

In accordance with a further aspect of the invention, after determining whether observed vehicle information 12 matches a reported stolen vehicle from database 18, server 16 conveys either YES match 30 or NO match 32 to IO device 20, shown as stream 34. IO device 20 further conveys YES match 30 or NO match 32 to user 10 either audibly or in text form, shown as stream 36. Upon receipt of either YES match 30 or NO match 32, user 10 learns whether observed vehicle information 12 matches a vehicle that has been reported stolen, as determined by server 16. In accordance with the invention, server 16 stores said observed vehicle information 12 by user 10 and the determination of whether or not it matched a vehicle that has been reported stolen according to database 18 as either YES match 30 or NO match 32.

FIG. 2 illustrates the steps taken by user 10 after user 10 receives YES match 30 and learns that observed vehicle information 12 matches a vehicle that has been reported stolen. In accordance with the invention, upon receipt of YES match 30, user 10 reports the location of observed vehicle information 12 that is reported stolen to police 38, shown as stream 40. In an alternate embodiment, as illustrated by FIG. 3, user 10 reports the location of observed vehicle information 12 that is reported stolen to police 38 via input/output device 20, shown as streams 42 and 44. As is well known in the art, police issue a police report upon recovering a stolen vehicle. Accordingly, if police 38 eventually recover the vehicle that matches observed vehicle information 12, police 38 will issue a police report.

Following the preferred procedure, after user 10 reports location of observed vehicle information 12 to police 38, user 10 requests a reward 46 from server 16 for reporting of a stolen vehicle. User 10 inputs request for reward 46 into IO device 20, shown as stream 48. IO device 20 further conveys user's 10 request for reward 46 to server 16, shown as stream 50.

Further in accordance with the invention, upon receipt of request for reward 46, server requests police reports of recovered stolen vehicles from police 38, shown as stream 52. As a result, police 38 forward police reports 54 of recovered stolen vehicles to server 16, shown as streams 56a and 56b. In accordance with the invention, server 16 is configured to receive police reports 54 of recovered stolen vehicles.

After receiving police reports 54 of recovered stolen vehicles from police 38, server 16 compares said police reports 54 to stored observed vehicle information 12 by user and YES match 30 to determine and confirm whether the stolen vehicle that matches observed vehicle information 12 reported by user 10 was recovered by police 38, shown as step 58. If recovery of stolen vehicle is confirmed, server 16 conveys a YES response 60 and issues a reward 46 to user 10, shown as stream 62. User 10 consequently receives reward 46 for confirmation of a successful recovery by police 38. Alternately, if the stolen vehicle was not recovered by police 38, server 16 conveys a NO response 64 and communicates to IO device 20 that no reward 46 will be issued to user 10, shown as stream 66. IO device 20 further conveys to user 10 that no reward 46 will be issued because the stolen vehicle was not recovered by police 38, shown as stream 68.

In an alternate embodiment, user 10 does not request reward 46 from server 16 and reward 46 is issued if vehicle reported stolen according to vehicle information 12 and YES match 30 is recovered within a set time period following inquiry according to police reports 54 because system retains record of inquiry from user 10.

While the invention has been described with respect to certain preferred embodiments, as will be appreciated by those skilled in the art, it is to be understood that the invention is capable of numerous changes, modifications and rearrangements and such changes, modifications and rearrangements are intended to be covered by the following claims.

I claim:

1. A stolen vehicle reporting system comprising a method by which a user engages in the following steps:
subscribing to said reporting system for a fee;
observing information sufficient to identify a vehicle and its location;
contacting a server with a database of stored reported stolen vehicle information via an IO device;
entering said observed information via said IO device into said server;
receiving information from said server via said IO device identifying whether said vehicle is reported stolen;
reporting said location of said vehicle to police if said server reported said vehicle was stolen;
requesting a reward from said server for reporting of a stolen vehicle, said server comparing said request to police reports to determine if said stolen vehicle was recovered; and
receiving said reward from said server if recovery of said stolen vehicle is confirmed.

2. The method of claim 1 wherein said server compares said observed information against said stored information.

3. The method of claim 2 wherein said database is configured to receive updated reported stolen vehicle information.

4. The method of claim 3 wherein said server is configured to receive police reports of recovered stolen vehicles.

5. The method of claim 4 wherein said server stores said entered observed information.

6. The method of claim 4 wherein said reporting is via said IO device.

7. The method of claim 4 wherein said information includes license plate information.

8. The method of claim 4 wherein said information includes make, model, type, color and location information.

9. The method of claim 4 further comprising the step of entering an ID and password after contacting said server and before entering said observed information.

10. The method of claim 4 wherein said IO device is wireless.

11. The method of claim 4 wherein said contacting said server is accomplished through contacting a human operator who interfaces with said server.

12. A stolen vehicle reporting system comprising a method by which a user engages in the following steps:
observing information sufficient to identify a vehicle and its location;
contacting a server with a database of reported stolen vehicle information via a cellular telephone;
entering said observed information via said cellular telephone into said server;
receiving information from said server via said cellular telephone identifying whether said vehicle is reported stolen;
reporting said location of said vehicle to police if said server reported said vehicle was stolen;
requesting a reward from said server for reporting of a stolen vehicle, said server comparing said request to police reports to determine if said stolen vehicle was recovered; and
receiving said reward from said server if recovery of said stolen vehicle is confirmed.

13. The method of claim 12 wherein said database is configured to receive updated reported stolen vehicle information.

14. The method of claim 12 wherein said server is configured to receive police reports of recovered stolen vehicles.

15. The method of claim 12 wherein said contacting said server is accomplished through contacting a human operator who interfaces with said server.

16. A stolen vehicle reporting system comprising a method by which a user engages in the following steps:
observing information sufficient to identify a vehicle and its location;
contacting a server with a database of stored reported stolen vehicle information via an IO device;
entering said observed information via said IO device into said server;
receiving information from said server via said IO device identifying whether said vehicle is reported stolen, wherein said server stores said information;
reporting said location of said vehicle to police if said server reported said vehicle was stolen; and
receiving a reward from said server if recovery of said stolen vehicle is confirmed by comparing said information to police reports to determine if said stolen vehicle was recovered.

17. The method of claim 16 wherein said database is configured to receive updated reported stolen vehicle information.

18. The method of claim 16 wherein said server is configured to receive police reports of recovered stolen vehicles.

19. The method of claim 16 wherein said contacting said server is accomplished through contacting a human operator who interfaces with said server.
